(19) United States
(12) Patent Application Publication
(10) Pub. No.: US 2021/0133259 A1
(43) Pub. Date: May 6, 2021

(54) System and Method for Personalized Search

(71) Applicant: Hudson Bay Wireless LLC, St. Thomas, VI (US)

(72) Inventor: Paul Vincent Hayes, St. Thomas, VI (US)

(73) Assignee: Hudson Bay Wireless LLC, St. Thomas, VI (US)

(21) Appl. No.: 17/145,778

(22) Filed: Jan. 11, 2021

Related U.S. Application Data
(63) Continuation of application No. 13/651,394, filed on Oct. 13, 2012, now abandoned.
Application No. 13/651,394 is a continuation-in-part of application No. 13/068,775, filed on May 20, 2011, now abandoned.
Application No. 13/068,775 is a continuation-in-part of application No. 11/939,819, filed on Nov. 14, 2007, now Pat. No. 8,346,753.
(60) Provisional application No. 61/547,086, filed on Oct. 14, 2011.
(60) Provisional application No. 61/395,813, filed on May 18, 2010.
(60) Provisional application No. 60/921,794, filed on Apr. 4, 2007.
(60) Provisional application No. 60/859,034, filed on Nov. 14, 2006.

(51) Int. Cl. G06F 16/951; G06Q 30/02

(52) U.S. Cl. CPC G06F 16/951; G06Q 30/0256

(57) ABSTRACT

Personalization of Internet search is effected through the use of ResultRank and searcher selected profile attributes and searcher selected query context attributes. These attributes are also referred to as hats (worn by the searcher). Searcher privacy is maintained by allowing limited use of a searcher's profile by the search engine. Query language interpretation is improved by capture and use of searcher behavior and hat selection, in past search sessions, without storage of individual profile or context information. ResultRank is maintained and adjusted, on a per hat basis such that future, similarly hatted searchers benefit from these past sessions. An average of ResultRank, across searcher selected hats, is utilized for improved SERP ranking Recognition of QLP's is improved by use of the hats. Custom support of public and private language community circles is incorporated. The technique is applied to organic as well as sponsored results. Steps are taken to minimize the impact of any attempt to artificially adjust ResultRank.

### CROSS-REFERENCE TO RELATED APPLICATIONS

This application is a continuation of U.S. patent application Ser. No. 13/651,394, filed on Oct. 13, 2012, which is a continuation-in-part of U.S. patent application Ser. No. 13/068,775, filed on May 20, 2011, which claims the benefit of U.S. Provisional Application Ser. No. 61/395,813 filed on May 18, 2010 and which is a continuation-in-part application of U.S. patent application Ser. No. 11/939,819, filed on Nov. 14, 2007, now U.S. Pat. No. 8,346,753, which claims the benefit of U.S. Provisional Patent Application No. 60/859,034 filed on Nov. 14, 2006, and U.S. Provisional Patent Application No. 60/921,794 filed on Apr. 4, 2007. This application also claims the benefit of U.S. Provisional Patent Application No. 61/547,086 filed on Oct. 14, 2011. The entire disclosures of these applications are expressly incorporated herein by reference.

### BACKGROUND

### Filed of the Invention

The present invention relates most generally to a machine's interpretation of language communicated by a living entity or another machine. This invention is applicable when the living entity or other (first) machine communicates through speech, writing, thought, brain wave patterns, electro-magnetic fields, images, use of photons, physical movement, or in any other manner; and another (second) machine or living entity is able to detect this signal. For simplicity we will refer to the living entity or first machine as the “entity” and the second machine or living entity as just the “machine”. It is also necessary for the machine to be able to communicate in some manner back to the entity. To facilitate communication, the machine then presents the entity with one or more choices of language interpretation. The entity then has an opportunity to authoritatively select the best interpretation and/or reject an interpretation. Importantly, the authoritative selection/rejection decisions are captured by the machine and this information is used by the machine to improve future interpretations made by similar language users, in a similar context.

### Related Art

Communication that occurs as part of this invention, is similar to what is used by Internet search engines, as a human (entity) enters a query and receives a SERP (Search Engine Results Presentation) from the search engine for review, then the human authoritatively clicks-through on individual results. Google co-founder, Larry Page is said to have stated that the “perfect search engine” is one that “understands exactly what you mean and gives you back exactly what you want.” Thus a search engine has two main problems. The first problem is to interpret what the searcher is searching for and the second problem is to locate the most relevant information. Most popular search engines have focused on the second problem and do a reasonable job with locating available information. However, the interpretation of the query is typically done without knowing or caring who the searcher is, or anything relevant about the searcher. Search engines are beginning to tailor search results based on the physical location of a searcher and based on the so-called “social graph” of a searcher (i.e. who their purported friends, acquaintances, and relatives are). However, present day popular search engines ignore a searcher's past personal experience and attempt to interpret their query language without the benefit of knowing which speech communities the searcher is a member of, or specifically which fields of interest the searcher currently has in mind. Thus there is a lack of personalization in present day search sessions. In order to work in an acceptable manner, current day search engines are also very dependent on a particular language. For example, Google and Bing do a good job with English; and Baidu does a good job with Chinese. However, search engines, in general are currently not able to effectively handle searchers whose first language they were not designed to support. Further, considerable research has gone into the study of speech communities, within a single language; and how language is used by these different communities. The focus on support for a single generic official language, by popular search engines effectively ignores the existence of discrete speech communities. Thus there is a need for search engines to effectively handle searchers who have different language back grounds. In addition, when a searcher enters a query and reviews the search results returned by the search engine, the searcher is doing work and applying their personal expertise to the problem of selecting an appropriate search result. Currently search engines may monitor the click behavior of a searcher during a search session, but this information is typically not considered in light of the background of the searcher and is not effectively utilized in order to improve the quality of future SERPs. In addition, any sort of profiling is typically done in a manner which intrudes on an individual's privacy, without their control/ownership of the profile information, often only in an effort to market goods or services to this individual. Thus what is lacking and what this invention provides, is a means of systematically harvesting and utilizing the information content in searcher decision making; when taken in context of the background of an individual searcher and the general field they are searching in; all in a manner which preserves an individual's privacy.

### SUMMARY

This invention addresses the first half of a search engine's problem space, understanding what the searcher wants. It does this by providing a mechanism for personalizing each search session. This invention allows the searcher to select from a multiplicity of attributes in order to self-profile themselves; prior to the conduct of each search session. The search engine of this invention then uses these attributes to improve the interpretation of the searcher's query based on past search sessions, by previous searchers, who had self-selected any of the same profiling attributes.

This invention relies on and can benefit from the existence of patterns of language, vocabulary, and understanding that are in use, or may be in use in the future, among a multiplicity of distinct speech communities. These language patterns are commonly used and uniquely understood by individuals within these speech communities. As a part of this invention, searchers select attributes in order to identify which speech communities they are members of. These profile attributes are alternately referred to herein, as “hats”. As such, the profile characteristics are combinations of hats that may be simultaneously and selectively “worn” by a searcher during any given search session. In addition, hats can be selected to indicate a general field that a query relates to. The selection of hats “worn” by a searcher, serve to identify the past experience of the searcher and/or the general field of knowledge the searcher is currently interested in, to the search engine. This knowledge indirectly improves the interpretation of the search query, by more appropriately ranking the set of matching search results and/or formulating and proposing alternate query language. Importantly, the search engine does not store any personally identifying or profiling information related to an individual searcher, beyond the duration of the search session. The combination of hats selected by the searcher remains the property of the searcher and can be used, deleted, modified, encrypted and/or stored, at the discretion of the searcher. During the search session the inferred satisfaction of the searcher with a particular result abstract is associated by the search engine with the self-selected characteristics (combination of hats). This association is stored in a retrievable manner using the ResultRank algorithm, as modified for use with hats. When searchers select a set of hats, they benefit from a refined ranking of result abstracts which match their search query, based on past search sessions conducted by similarly “hatted” searchers.

### DETAILED DESCRIPTION

### Use of ResultRank

One embodiment of the present invention serves to rank search result abstracts returned by a search engine in response to a searcher-entered query. The ranking algorithm is selectively, a hybrid of ResultRank and link-based ranking Based on the use of ResultRank, indicated and/or inferred searcher satisfaction with the relevance of search result abstracts is incorporated into the future ranking of those result abstracts. The term Result Rank was introduced in U.S. patent application Ser. No. 11/939,819, filed Nov. 14, 2007, titled “System and Method for Searching for Internet-Accessible Content”. The algorithm was expanded on in U.S. patent application Ser. No. 13/068,775, filed May 20, 2011, titled “System and Method for Search Engine Result Ranking”. This algorithm is further expanded as part of this invention.

ResultRank with Hats

Importantly, the search engine of this invention offers general categories (profile attributes) for the searcher to select from in order to self-profile. The search engine also 135 offers general categories (context attributes) which can optionally be used by the searcher to put their search query in context, which serves to help disambiguate their query and in turn provide a more relevant set of matching results, prior to ranking. The self-profiling and contextual attributes are offered by the search engine, prior to the search session. Each profiling attribute then helps to answer the question of who the searcher is in terms of how they use language (while simultaneously maintaining personal privacy). Each contextualizing attribute selection serves to answer the question of what general area of interest the query is associated with. This information (who is asking and what they are asking about in general) is useful to the search engine when interpreting the query. These attributes (profile and contextual) may be communicated to the search engine a priori, or along with the user query. The pre-selected profiling and contextualizing attributes are used by the search engine's ranking algorithm to rank the returned result abstracts. As a part of the ResultRank algorithm, the searcher's behavior during the search session is monitored by the search engine in order to infer satisfaction with specific result abstracts. In this invention, the inferred level of satisfaction with individual result abstracts is associated with the profile and contextual attributes in a manner that can be used to adjust (up or down) the abstract's ResultRank array, for use in future search sessions. What the search engine learns from each search session is used to improve the ranking of future SERPS (Search Engine Result Presentations), when these future search sessions are conducted by similarly self-profiled searchers, or in a similar context. This cycle effects a means of both personalizing and contextualizing a search session; and further a means of learning from a search session, storing what is learned, and using what is learned to improve future search sessions. Each profiling attribute then helps to answer the question of who the searcher is in terms of how they use language (while simultaneously maintaining personal privacy). Each contextualizing attribute selection serves to answer the question of what general area of interest the query is associated with. This information (who is asking and what they are asking about in general) is useful to the search engine when interpreting the query.

The search engine of this invention will maintain a ResultRank array for each result abstract. This array is used to rank the set of result abstracts that match a query. In one variant of this invention there is one spot in the array for each hat. In this variant the average of all values in the array is the ResultRank for the associated result abstract. In another variant of this invention there is one spot in the array for each possible combinations of searcher hat selection. The ResultRank for the search result abstract is a value indexed. The index to this value is determined by the combination of hats selected and associated with each query. Since there are more possible combinations of hats, than there are hats, this second variant is more demanding in terms of storage and computation resources required. However, the first variant does not offer as fine a determination of overall ResultRank as the second. When taking a simple average, the contribution by one or two significant hats can be masked by less relevant hat values. So there is a trade-off between accuracy and time and resources. If sufficient storage and computational resources are available then the second variant, the primary intended variant for this invention, is best. If not, then the first variant will still produce better results existing algorithms. How demanding is the second variant? In general, if there are a total of N profile attributes which a searcher can select from and the searcher is limited to M contextual attributes to choose from; and the searcher may select any combination of any number of the profile attributes, and the searcher may select only one contextual attribute for each search query submittal, then each result abstract known to the search engine may have a total number of X different ResultRanks. Where X is calculated by finding the product of M times the sum of

N things taken in combination of 1, plus

N things taken in combination of 2, plus

N things taken in combination of 3, plus

. . .

N things taken in combination of N.

For example, if there are four (4) possible profile attributes and 2 possible contextual attributes, then the search engine will keep track of 30 different result rankings for each result abstract. Any one of these 30 different ResultRanks may be applied for a given query, depending on the hats in effect at query submittal time.

The number 30 is arrived at by finding the product of 2 times the sum of

(4 things taken in combinations of 1)+

(4 things taken in combinations of 2)+

(4 things taken in combinations of 3)+

4 things taken in combinations of 4)

Which is →

2×[4!/1!3!+4!/2!2!+4!/3!1!+1]

Which is →2×[24/6+24/4+24/6+1]

Which is →2×[4+6+4+1]=2×15=30.

So in this particular case, there could be as many as 30 different ResultRanks associated with each search abstract. Put another way, for a given query, the SERP order will be personalized, by assigning one of as many as 30 different ranks, to each result abstract; the rank being dependent on the searcher's exact profile and current area of interest hat selection. For this same example, the first variant would need to maintain a ResultRank array with 6 (=4+2) spots in it. It can be seen that the primary intended variant is sensitive to the number of hats available for selection. In one embodiment of this invention the search engine may arbitrarily limit the number of profile and/or contextual attributes which the searcher can select from, and/or which the search engine considers for any given query and/or for any given period of time. This may be done by the search engine in order to reduce computation time and/or memory storage requirements and/or conserve communication channel bandwidth; as deemed necessary by the search engine. For example, in one embodiment of this invention, a search engine may limit the number of profile selections to choose from, to ten (10) and the number of contextual attribute selections to one (1).

### Profile Ownership and Privacy

In one embodiment of this invention, for purposes of privacy/security, neither the query, nor any of the attributes selected by the searcher are stored by the search engine beyond the duration of the search session. Communication between the searcher and the search engine may be encrypted in order to further protect searcher privacy. The selected attributes may be stored in an encrypted manner based on mutual understanding of the decryption process by both the searcher and the search engine. In one embodiment of this invention, no personally identifying or profiling information related to the searcher is stored by the search engine. Selected profile and contextual attributes may be stored locally on equipment used to conduct the search session, stored in the Internet cloud, or stored by a mutually trusted third party, based on mutual understanding between the searcher and the search engine of their decryption and access protocol. Importantly, the searcher owns and remains in complete control of all selected attributes at all times.

### Socializing and Personalizing

The searcher also has the ability to create custom (both profile and context) attributes of their own design. These custom attributes can be public or private in nature. The custom public attribute definitions are accompanied with descriptive text and/or keywords supplied by the searcher to the search engine. In one embodiment of this invention a limit of 140 characters is imposed on the descriptive text. These public attributes are then made available by the search engine for selection and use by other searchers. Descriptive text is optional for the private attributes. However, each private attribute has an associated name and strong password, which are selected by the creator of the private attribute. Other users will not be presented with a selection of the names or descriptions of the private attributes and must independently (of the search engine) know the names and passwords, beforehand, in order to be able to select the private attributes (wear those hats). The use of private attributes, in one embodiment of this invention will allow members of a particular social network (friends or circles of friends), who may constitute a speech community, to benefit from their association by sharing access to and use of any private attributes during search sessions.

One intended use of the hats is to describe and delineate speech communities. A speech community can be defined as “a sociolinguistic concept that describes a more or less discrete group of people who use language in a unique and mutually accepted way among themselves.” As such the hats will be used to represent such things as, but not limited to, the following characteristics and/or areas of interest: age, ethnicity, gender, religion, social status, educational background, first language, second language, third language, past employment experience, hobbies, geographical location, branch of science, branch of learning, profession. Thus the search engine of this invention makes allowance for individuals which may be members of combinations of multiple different speech communities, to implement a form of machine learning based on the results of each searcher's interaction with the SERP returned for each query.

### Query Language Progression (QLP) Recognition

The selection of profile hats says: “this is who the searcher is (from a language perspective)” and contextual hats say: “this is the general area that I am searching in.” Given this additional knowledge the search engine is better able to identify Query Language Progressions (QLPs) and formulate alternate query language suggestions. Note that voting on specific results, QLPs and alternate query language suggestions were introduced in U.S. patent application Ser. No. 11/939,819, filed Nov. 14, 2007, titled “System and Method for Searching for Internet-Accessible Content”. QLPs are more likely to be applicable to two different searchers who are in the same speech community. Recognizing new QLPs is thus simplified. QLPs are identified by the search engine over time, by storing, processing, and comparing the query language used from multiple users, over multiple search sessions. As a searcher enters a series of queries, one after the other, within some acceptable time period; the search engine will monitor the series of queries in an attempt to determine if the language of the searcher used in each query, is “progressing” toward a known end query that will satisfy the searcher's goal. The series or progression of queries is compared with a stored set of similar progressions (QLP's), with the intent of predicting the final query desired by the searcher, in order to suggest alternate query language, so as to save the searcher time and effort. The query language may not be exact at the beginning or middle of a QLP, but the progressions all converge toward the same final query, which produces alternate query language which may be presented to the searcher and/or used to produce a desired SERP. Considerable judgment (machine intelligence) is required to separate a QLP from a series of distinctly different search sessions, which happen to be immediately adjacent to each other in time. Thus in one embodiment of this invention statistical processing of multiple search sessions from multiple searchers is used to weed out QLPs from separate search sessions that just happen to occur in the same time frame and to help recognize the pattern of a QLP.

In one embodiment of this invention, the selection of contextual attributes is optional and may be skipped by the searcher. In this case, the search engine makes a guess as to the field of general interest based on the language in the query and may propose a shortened list of contextual attributes to optionally choose from following query submittal, in order to further improve the SERP.

### Application to Sponsored Results

In one embodiment of this invention, the herein described techniques are applied to the ranking and maintenance of ResultRank for both organic and sponsored results. Organic results are ordered by popular search engines using link-based algorithms. Sponsored results handled differently. Key words are auctioned off to the highest bidder (sponsor). The sponsor has thus purchased the right to be presented. Some search engines report that placement is also based on some degree of searcher use (inferred satisfaction) with the result. If this is true, then the use of a ResultRank array and hats will fit in well with the existing scheme of sponsored result presentation. Regardless, it will serve to better personalize the ranking and presentation choices of sponsored results. Since searchers are more likely to click-through on a sponsored result that is more relevant to them, more purchases are made. It is thus a win-win-win scenario for the searcher, the search engine, and the sponsors.

### Private Ballot Voting

In one embodiment of this invention, the searcher may be allowed to vote in a positive as well as a negative manner for each returned result; assuming they are “wearing” a hat identified to represent a particular election or survey. As described in previous patents and patent applications incorporated in this application by reference, such votes are handled in a special manner, with the fact that a particular user voted at all, stored in a database separate from the cumulative up/down tally for each result. Thus it is a private ballot in the sense that the direction a particular user votes for a particular topic is not stored. If the vote is negative, then the associated ResultRank may be adjusted downward, in a manner similar to the adjustment technique used to adjust ResultRank upward for a positive vote and/or inferred positive vote.

### ResultRank Adjustment Conditional on Authority

In one embodiment of this invention ResultRank is updated based on searcher behavior, only when one or more of a searcher's selected contextual attributes matches one or more of the same searcher's selected profile attributes, at the time of query submittal. A match of this sort would be taken to indicate that a searcher is searching in a field in which they have some expertise; and thus can be considered an authority in the particular field; and thus their result abstract selections/rejections are more authoritative than those of others. This condition is used to further improve the confidence level in the searcher's expertise, such that only self-identified experts in a particular field of interest are allowed to impact associated ResultRank.

ResultRank Adjustment Conditional on Profile Stability

In another embodiment of this invention, a searcher's personally identifying information (i.e. IP address) is one-way hashed with after being combined with the searcher's selection of profile hats. This one-way hash is stored by the search engine and used to check for matches during future search sessions conducted by the same searcher in order to verify stability in the searcher's professed profile. Stability in the profile is then used as a condition for allowing the searcher's behavior to impact ResultRank. This is done in an effort to reduce attempts to game or inadvertently adversely impact search engine ranking. The benefit of a one-way hash is that the searcher's privacy is preserved.

### ResultRank Adjustment Conditional on Time Delay

To help prevent malicious or inadvertent miss-use of the search engine, a unique searcher identifier (such as an IP address) may be combined with a time period stamp of the search session and further combined with a search result unique identifier (the more significant portion of the URL, as much of it as is required to be unique) which was inferred to be relevant (e.g. subject to adjustment of its associate ResultRank). A one-way hash of this combination (searcher Id+time period stamp+search result Id), is calculated and stored by the search engine each time the associated ResultRank array is adjusted. This one-way hash is then used by the search engine to limit the effect that one searcher can have on the rank of a given search result within the identified time period. The time period stamp is chosen to represent a period of time—perhaps a month or more--during which the time stamp remains constant and the same user is not allowed to impact the ranking of the same result more than once. This is a measure designed to preclude attempts to game the ranking algorithm. The benefit of a one-way hash is that the searcher's privacy is preserved. Regardless of the query, or the selected attributes, the search engine calculates the one way hash of the combination of time period stamp, user identifier, and result abstract; for each search session that has the potential for adjustment of the ResultRank array. This calculated hash is then checked against a stored database of one-way hashes. If there is no match, then the searcher's behavior may be used to impact the ResultRank array; else the behavior of the searcher is not allowed to update the ResultRank array for the particular result. Once the selected time period elapses and the time period stamp increments, the calculated hash will no longer match with a previously calculated hash and the searcher's activity will again be allowed to influence ResultRank. Associated with each hash record in the database is a record expiration time, which is used in combination with the ticking of the time period to do garbage collection on the memory, utilized by the database. In other words old hashes are aged out and flushed from the database when the time period increments and records expire. In one embodiment of this invention, each hash record in the database is keyed by searcher ID to speed lookup time.

Having thus described the system and method in detail, it is to be understood that the foregoing description is not intended to limit the spirit or scope thereof. It will be understood that the embodiments of the present disclosure described herein are merely exemplary and that a person skilled in the art may make any variations and modification without departing from the spirit and scope of the disclosure. All such variations and modifications, including those discussed above, are intended to be included within the scope of the disclosure. What is intended to be protected by Letters Patent is set forth in the following claims.

What is claimed is:

1. A system for improving Search Engine operations on a plurality of computer networks, comprising:
a search engine; and
a local computing device having a set of self-profiling attributes relating to a searcher;
the local computing device accepting a search query from the searcher, combining the profiling attributes with the search query, and communicating a resulting combination of the profiling attributes and the search query to the search engine; and
the search engine selecting a set of matching search results based on relevance to the search query, ranking the set of search results depending on at least one of the query and the attributes relating to the searcher, and communicating a set of ranked search engine results to the local computing device.
